(19) United States
(12) Patent Application Publication
(10) Pub. No.: US 2009/0100451 A1
(43) Pub. Date: Apr. 16, 2009

(54) GEAR MECHANISM AND DISK TRAY DEVICE

(75) Inventors: Ryuuji Hayashi, Osaka (JP); Katsuo Ichinohe, Osaka (JP)

Correspondence Address: GLOBAL IP COUNSELORS, LLP, 1233 20TH STREET, NW, SUITE 700, WASHINGTON, DC, 20036-2680, US

(73) Assignee: FUNAI ELECTRIC CO., LTD., Osaka (JP)

(21) Appl. No.: 12/247,685

(22) Filed: Oct. 8, 2008

(30) Foreign Application Priority Data
Oct. 10, 2007 (JP) 2007-264020

(51) Int. Cl. G11B 17/04

(52) U.S. Cl. 720/607; G9B/17.013

(57) ABSTRACT

A gear mechanism includes a first rack, a second rack and a gear component. The first rack is provided to a disk tray that is configured to move between a retracted position and an ejected position. The second rack is provided to a slider that is configured to reciprocally move between a first end position and a second end position. The gear component has a first gear, a second gear and an input gear. The first gear selectively meshes with the first rack to move the disk tray between the retracted position and the ejected position. The second gear selectively meshes with the second rack to move the slider between the first end position and the second end position. The input gear operatively coupled to the first and second gears. The first gear and the second gear have equal number of teeth and different modules.

### CROSS-REFERENCE TO RELATED APPLICATIONS

This application claims priority to Japanese Patent Application No. 2007-264020 filed on Oct. 10, 2007. The entire disclosure of Japanese Patent Application No. 2007-264020 is hereby incorporated herein by reference.

### BACKGROUND OF THE INVENTION

1. Field of the Invention

The present invention generally relates to a gear mechanism. More specifically, the present invention relates to a gear mechanism for ejecting and retracting a disk tray.

2. Background Information

With disk devices such as DVD drives, a disk tray moves between a retracted position and an ejected position. The retracted position corresponds to an optical processing position of an optical pickup. The ejected position corresponds to the opposite end to the retracted position. An optical disk is loaded by the disk tray to the optical processing position. The optical disk is clamped to or unclamped from a turntable through reciprocal movement of a slider. The movement of the disk tray and the reciprocal movement of the slider are accomplished by a gear mechanism. The gear mechanism includes first and second racks provided to the disk tray and the slider, respectively, and first and second gears that mesh with the first and second racks, respectively. The first rack provided to the disk tray is separated from the first gear when the disk tray locates at the retracted position and the ejected position. The second rack provided to the slider is separated from the second gear at back and forth limits of the reciprocal movement of the slider.

In the gear mechanism, for the disk tray to be moved smoothly between the retracted position and the ejected position, it is required for the first rack to be meshed smoothly with the first gear upon an initial movement of the disk tray during an ejection and an retraction of the disk tray. Furthermore, for the slider to be moved smoothly between the back and forth limits, it is required for the second rack to be meshed smoothly with the second gear upon an initial movement of the slider during the reciprocal movement (smoothness of meshing). Also, it is required for torque transmitted from the first gear to the first rack and movement speed of the first rack to be suitable during the ejection and the retraction of the disk tray. Furthermore, it is required for torque transmitted from the second gear to the second rack and movement speed of the second rack to be suitable during the reciprocal movement of the slider (suitability of the torque and movement speed).

Three types of gear components are conventionally used to transmit torque by meshing with the first rack of the disk tray and with the second rack of the slider.

The first type of the gear component includes a single input gear and a common gear. A rotation of a motor is transmitted to the input gear via a pulley and a relay gear. The common gear meshes with both a first rack of a disk tray and a second rack of a slider. The gear component is integrally formed from a resin. With the gear component, since the first and second racks are designed to mesh with the common gear, the torque transmitted to the first and second racks and the movement speed thereof are the same for both. Thus, it is difficult to achieve the above-mentioned suitability of the torque and movement speed.

The second type of gear component includes an input gear and a first gear. A rotation of a motor is transmitted to the input gear via a pulley and a relay gear. The input gear and the first gear are integrally formed from a resin. The first gear meshes with a first rack of a disk tray. The input gear meshes with a second rack of a slider. With the gear component, it is difficult to achieve the above-mentioned smoothness of meshing because the input gear and the first gear have different numbers of teeth and relative positions between the teeth of the first rack and the first gear and relative positions between the teeth of the input gear and the second rack vary when the first rack or the second rack begins to mesh with the first gear or the input gear.

The third type of gear component includes a first gear that meshes with a first rack of a disk tray, and a second gear that meshes with a second rack of a slider. The first and second gears are formed as independent parts. A rotation of a motor is transmitted to the first and second gears via a relay gear. With this configuration, because separate gears are used for the first rack and the second rack, more parts are required and the assembly process is more complicated.

Meanwhile, with a conventional loading mechanism for an optical disk player, a transition from a tray loading operation to a disk clamping operation is carried out by employing a gear mechanism having a sun gear and a planet gear (see Japanese Laid-Open Utility Model Application Publication No. H5-86137, for example). Also, with a conventional loading device for a disk device, a movement speed of a guide tray and a turntable is optimized by adjusting a peripheral speed of corresponding gear components (see Japanese Laid-Open Patent Application Publication No. H4-345956, for example). Furthermore, with a conventional optical disk device, a common drive source is used to perform a pickup feed operation, a turntable elevation operation, and a disk transport operation (see Japanese Laid-Open Patent Application Publication No. 2005-174427, for example).

With the conventional gear components discussed above, it is difficult to achieve the above-mentioned smoothness of meshing and suitability of the torque and movement speed.

In view of the above, it will be apparent to those skilled in the art from this disclosure that there exists a need for an improved gear mechanism. This invention addresses this need in the art as well as other needs, which will become apparent to those skilled in the art from this disclosure.

### SUMMARY OF THE INVENTION

The present invention is conceived in light of the above-mentioned problems. On object of the present invention is to provide a gear mechanism with which smoothness of meshing and suitability of torque and movement speed can be achieved.

In accordance with one aspect of the present invention, a gear mechanism includes a first rack, a second rack and a gear component. The first rack is provided to a disk tray that is configured to move between a retracted position and an ejected position. The second rack is provided to a slider that is configured to reciprocally move between a first end position and a second end position. The gear component has a first gear, a second gear and an input gear. The first gear is selectively meshed with the first rack to move the disk tray between the retracted position and the ejected position. The second gear is selectively meshed with the second rack to move the slider between the first end position and the second end position. The input gear operatively couple to the first and second gears to transmit a rotation of a motor to the first and second gears. The first gear and the second gear have the same number of teeth and different modules.

With the gear mechanism of the present invention, it is possible to provide a gear mechanism with which smoothness of meshing and suitability of torque and movement speed can be achieved.

These and other objects, features, aspects and advantages of the present invention will become apparent to those skilled in the art from the following detailed descriptions, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a plan view of a gear mechanism of a disk tray device in accordance with an embodiment of the present invention;

FIG. 2 is a simplified side view of the gear mechanism illustrated in FIG. 1;

FIG. 3 is a simplified plan view of the disk tray device;

FIG. 4 is a simplified plan view of the disk tray device illustrating another state;

FIG. 5 is a simplified plan view of the disk tray device illustrating yet another state;

FIG. 6 is a simplified plan view of the disk tray device illustrating yet another state; and

FIG. 7 is a simplified side view of a gear component in accordance with another embodiment of the present invention.

### DETAILED DESCRIPTION OF THE PREFERRED EMBODIMENT

A preferred embodiment of the present invention will now be explained with reference to the drawings. It will be apparent to those skilled in the art from this disclosure that the following description of the preferred embodiment of the present invention is provided for illustration only and not for the purpose of limiting the invention as defined by the appended claims and their equivalents.

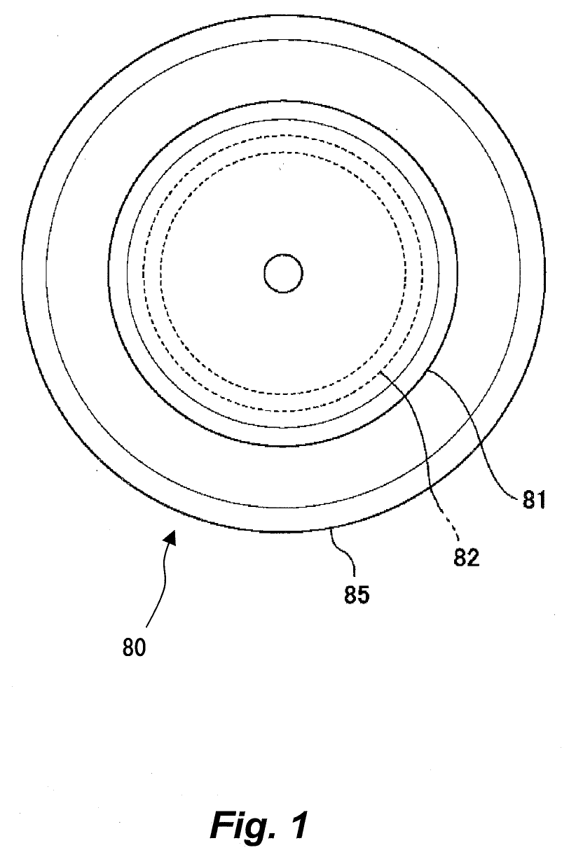

As shown in FIGS. 1-6, a disk tray device includes a disk tray 10, a slider 20 and a gear mechanism. The disk tray 10 moves forward and backward between a retracted position and an ejected position. The retracted position corresponds to an optical processing position of an optical disk mounted to the disk tray device. The ejected position locates behind the retracted position. The ejected position corresponds to the opposite end to the retracted position. The slider 20 reciprocally slides between limits of back and forth movement (between a first end position and a second end position).

The disk tray device is provided within disk devices such as DVD drives. The optical disk is loaded by the disk tray to the optical processing position. The optical disk is clamped to or unclamped from a turntable through reciprocal movement of the slider 20. The movements of the disk tray 10 and the reciprocal movement of the slider 20 are accomplished by the gear mechanism. The gear mechanism includes a first rack 11, a second rack 21 and a gear component 80. The first rack 11 is provided to the disk tray 10. The second rack 21 is provided to the slider 20.

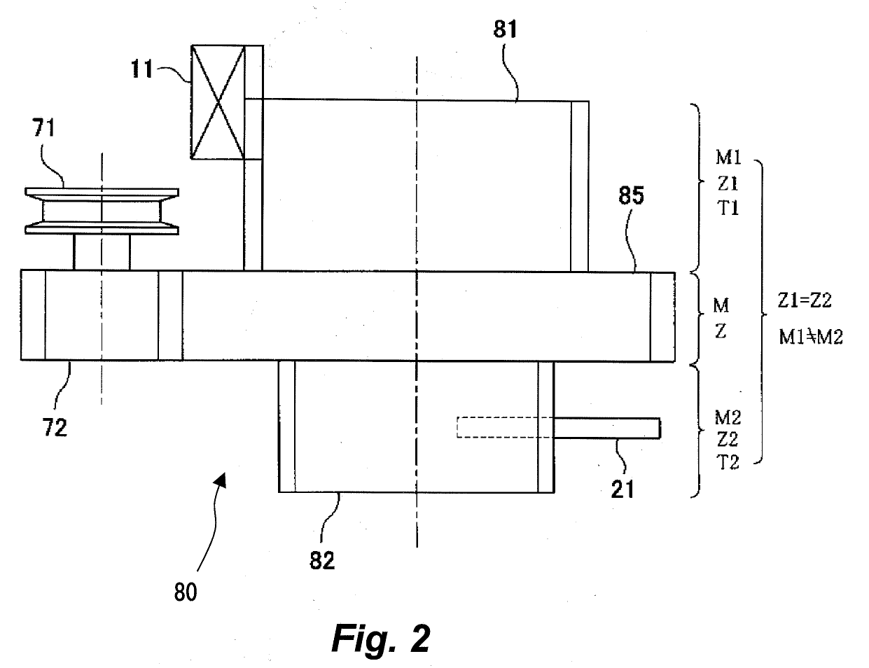

As shown in FIGS. 1 and 2, the gear component 80 includes a first gear 81, a second gear 82 and a single input gear 85. The first gear 81 is provided corresponding to the disk tray 10. The first gear 81 meshes with the first rack 11 to move the disk tray 10 between the retracted position and the ejected position. The first gear 81 also separates from the first rack 11 when the disk tray 10 locates at the retracted position and the ejected position. The first gear 81 meshes with the first rack 11 by an initial movement of the disk tray 10 during an ejection and a retraction of the disk tray 10. Here, the ejection of the disk tray 10 means a movement of the disk tray 10 from the retracted position towards the ejected position. The retraction of the disk tray 10 means a movement of the disk tray 10 from the ejected position towards the retracted position. The second gear 82 is provided corresponding to the slider 20. The second gear 82 meshes with the second rack 21 to move the slider 20 between the back and forth limits of the reciprocal movement of the slider 20. The second gear 82 also separates from the second rack 21 when the slider 20 locates at the back and forth limits of the reciprocal movement of the slider 20. The second gear 82 meshes with the second rack 21 by an initial movement of the slider 20 from the back and forth limits. The input gear 85 transmits a rotation of a motor (not shown) to the first and second gears 81 and 82, respectively. Specifically, the disk device further includes a pulley 71 and a relay gear 72. The rotation of the motor is transmitted to the gear component 80 via the pulley 71 and the relay gear 72. Specifically, the pulley 71 is coupled to a rotational axle of the motor via a belt. The relay gear 72 is concentrically provided to the pulley so that the pulley 71 and the relay gear 72 rotate together. The relay gear 72 meshes with the input gear 85.

As shown in FIG. 2, the first gear 81 and the second gear 82 are disposed concentrically, on both sides flanking the input gear 85. In other words, the input gear 85 is concentrically disposed between the first and second gears 81 and 82. The first and second gears 81 and 82 and the input gear 85 are concentrically disposed. The input gear 85, the first gear 81 and the second gear 82 together form a three-stage gear structure made of a single resin molding. In other words, the gear component 80 is integrally formed as a one-piece, unitary member. The input gear 85 has an outside diameter that is greater than outside diameters of the first and second gears 81 and 82. Also, the number of teeth and the module of the input gear 85 are set so that the outside diameter of the input gear 85 is greater than the outside diameter of the first gear 81 and the outside diameter of the second gear 82. Thus, the three-stage gear structure of the gear component 80 can be easily formed using a simple split metal mold.

In FIG. 2, the number of teeth of the input gear 85 is indicated by Z, the module of the input gear 85 by M, the number of teeth of the first gear 81 by Z1, the module of the first gear 81 by M1, the drive torque of the first gear 81 by T1, the number of teeth of the second gear 82 by Z2, the module of the second gear 82 by M2, and the drive torque of the second gear 82 by T2.

With the gear component 80, the numbers of teeth Z1 and Z2 are the same between the first gear 81 and the second gear 82, but the modules M1 and M2 are different. Preferably, the module M1 of the first gear 81 is greater than the module M2 of the second gear 82. As shown in FIG. 2, the outside diameter of a pitch circle of the first gear 81 is greater than the outside diameter of a pitch circle of the second gear 82. Also, the input gear 85 has the number of teeth Z and the module M that are different from the numbers of teeth Z1 and Z2 and the modules M1 and M2 of the first gear 81 and the second gear 82. Here, the module of a gear corresponds to a quotient obtained by dividing the diameter of a pitch circle of the gear by the number of teeth of the gear. In other words, the module indicates the tooth size and is the number of mm of pitch circle diameter per tooth.

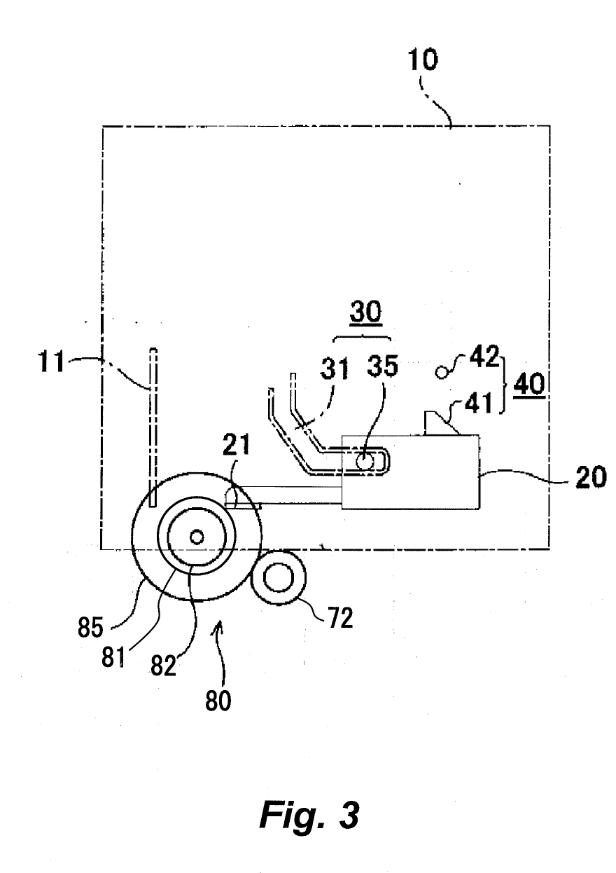

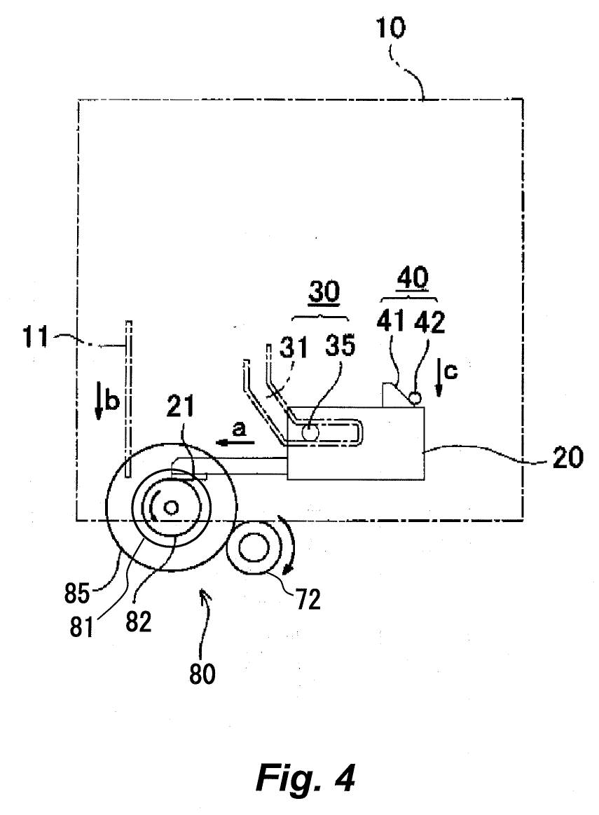

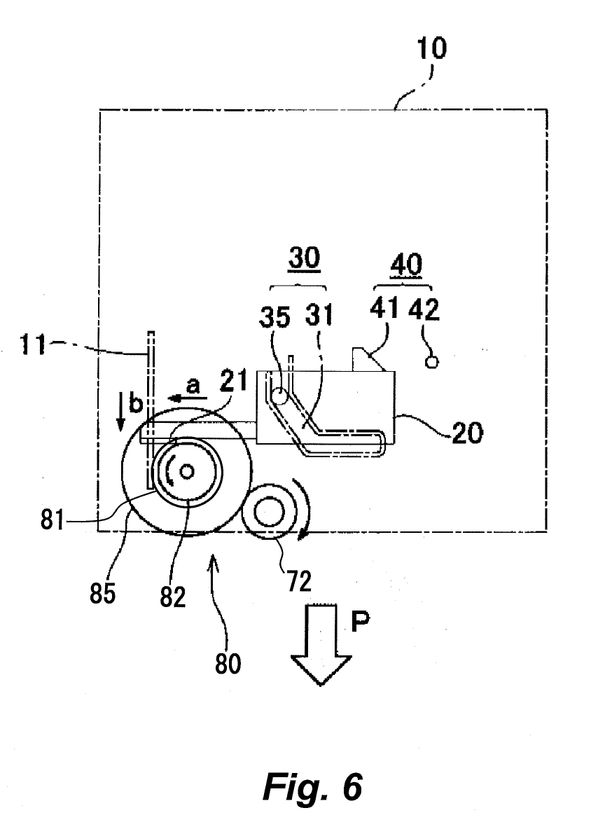

As shown in FIGS. 3-6, the disk tray 10 and the slider 20 are linked via a cam mechanism 30. Specifically, the cam mechanism 30 includes a cam groove 31 and a cam pin 35. The cam groove 31 is provided on the disk tray 10. The cam pin 35 is provided on the slider 20. When the slider 20 moves leftward from the state shown in FIG. 3 as indicated by an arrow a in FIG. 4 (from the first end position towards the second end position), the disk tray 10 ejects as indicated by an arrow b in FIG. 4. In contrast, when the disk tray 10 retracts from the state shown in FIG. 6 in the opposite direction of the arrow b, the slider 20 moves rightward in the opposite direction of the arrow a (from the second end position towards the first end position).

The slider 20 and an optical pickup (not shown) are linked by a separate cam mechanism 40. Specifically, the cam mechanism 40 includes a cam face 41 and a cam pin 42. The cam face 41 is provided on the slider 20. The cam pin 42 is provided on the optical pickup. As the optical pickup returns to a home position as indicated by an arrow c in FIG. 4, the cam pin 42 pushes on the cam face 41 and moves the slider 20 leftward as indicated by the arrow a.

In the state shown in FIG. 3, the disk tray 10 is in the retracted position and the slider 20 is located at the first end position, at which point the first rack 11 and the second rack 21 are away from the gear component 80.

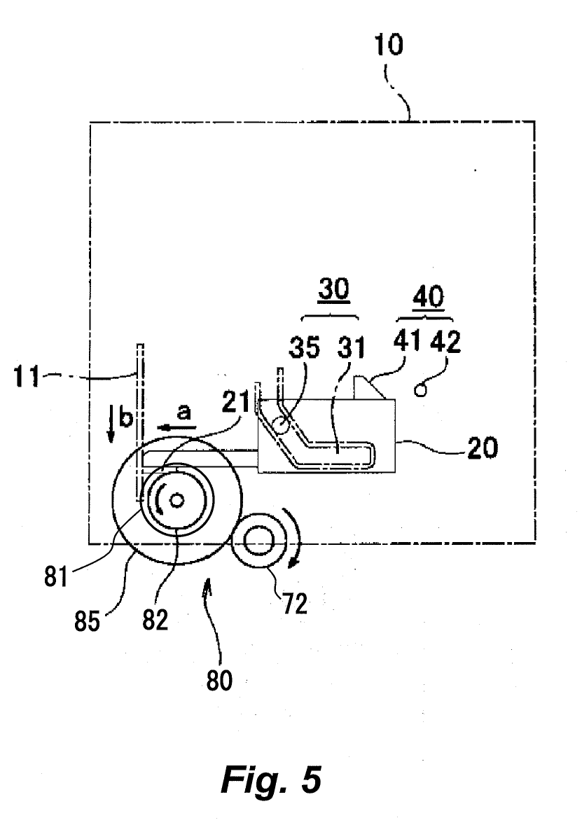

When the optical pickup returns from the state in FIG. 3 to the home position, the cam pin 42 pushes on the cam face 41 as indicated by the arrow c in FIG. 4, and moves the slider 20 leftward as indicated by the arrow a. The leftward movement of the slider 20 at this point is an initial movement of the slider 20 during the leftward movement of the slider 20 from the first end position to the second end position. The initial movement of the slider 20 causes the second rack 21 to approach and mesh with the second gear 82 as shown in FIG. 4. When the initial movement of the slider 20 causes the second rack 21 to mesh with the second gear 82, since the rotation of the motor is transmitted by the input gear 85 to the second gear 82, the second rack 21 is moved leftward as indicated by the arrow a in FIG. 5. Thus, the slider 20 moves leftward in the direction of the arrow a. In conjunction with the leftward movement of the slider 20 after the initial movement of the slider 20, the action of the cam mechanism 30 as shown in FIG. 5 causes the disk tray 10 to commence an initial movement of the ejection of the disk tray 10 as indicated by the arrow b, and the first rack 11 meshes with the first gear 81. In other words, the initial movement of the ejection of the disk tray 10 is linked to the leftward movement of the slider 20 after the slider 20 initially moves leftward. After this, as indicated by an arrow P in FIG. 6, the rotation of the first gear 81 causes the disk tray 10 to eject toward the ejected position. Also, the ejection movement of the disk tray 10 after the initial movement of the ejection of the disk tray 10 causes the slider 20 to move to the second end position, and the second rack 21 separates from the second gear 82 (from FIG. 5 to FIG. 6). At the point when the disk tray 10 reaches the ejected position, the first rack 11 separates from the first gear 81.

The above operation is for the step in which the disk tray 10 ejects from the retracted position to the ejected position in the disk device. The reverse operation, that is, the step in which the disk tray 10 retracts from the ejected position to the retracted position, is carried out as follows.

The disk tray 10 in the ejected position is either pushed by the hand of the user or electromechanically controlled so that the disk tray 10 undergoes an initial movement of the retraction. Then, the first rack 11 meshes with the first gear 81. As a result, the rotation of the first gear 81 is transmitted to the first rack 11 and the disk tray 10 moves toward the retracted position. When the disk tray 10 is retracted, in the final movement that is carried out at the end of the retraction, the action of the cam mechanism 30 causes the slider 20 to undergo an initial movement from the second end position towards the first end position. In other words, the initial rightward movement of the slider 20 is linked to the final movement of the retraction of the disk tray 10. The initial movement of the slider 20 causes the second rack 21 to mesh with the second gear 82 (from FIG. 6 to FIG. 5). Once the second rack 21 meshes with the second gear 82, the rotation of the second gear 82 is transmitted to the second rack 21. As a result, the slider 20 moves rightward from the second end position towards the first end position. The action of the cam mechanism 30 when the slider 20 is thus moving rightward causes the disk tray 10 to reach the retracted position and the first rack 11 to separate from the first gear 81. The second rack 21 also separates from the second gear 82, returning to the state in FIG. 3.

As discussed above, with the disk device, when the second rack 21 meshes the second gear 82 and the slider 20 is moving leftward, the disk tray 10 undergoes the initial movement from the retracted position toward the ejected position. The initial movement of the disk tray 10 causes the first rack 11 to begin to mesh with the first gear 81. Also, when the first rack 11 meshes with the first gear 81 and the disk tray 10 retracts from the ejected position toward the retracted position, the slider 20 undergoes the initial movement from the second end position toward the first end position. The initial movement of the slider 20 causes the second rack 21 to begin to mesh with the second gear 82. Also, since it is the role of the slider 20 to perform the above-mentioned disk clamping and unclamping operation by means of the reciprocal movement, the torque transmitted from the second gear 82 to the second rack 21 has to be greater than the torque transmitted from the first rack 11 of the disk tray 10 to the first gear 81.

With the gear mechanism of the disk tray device, the numbers of teeth Z1 and Z2 are the same between the first gear 81 and the second gear 82. Thus, a meshing pattern (relative position) between the first rack 11 and the first gear 81 at the start of meshing of the first rack 11 with the first gear 81 by the initial movement of the disk tray 10 during the ejection and the retraction is consistent with a meshing pattern (relative position) between the second rack 21 and the second gear 82 at the start of meshing of the second rack 21 with the second gear 82 by the initial movement of the slider 20 during the reciprocal movement. As a result, the above-mentioned smoothness of meshing can be satisfied.

Also, since the modules M1 and M2 are different between the first gear 81 and the second gear 82, the torque transmitted to the first rack 11 and the second rack 21 and the movement speeds of the first and second racks 11 and 21 are different. Therefore, the above-mentioned suitability of the torque and the movement speed can be satisfied by suitably selecting the modules M1 and M2. Even if the number of teeth Z or the module M of the input gear 85 are different from the numbers of teeth Z1 and Z2 and the modules M1 and M2 of the first gear 81 and the second gear 82, this will still help to satisfy the above-mentioned suitability of the torque and movement speed. Therefore, the torque applied to the slider 20, whose role is to perform the disk clamping and unclamping operations by the reciprocal movement, can be made larger than the torque applied to the disk tray 10.

With the gear component 80,.the numbers of teeth Z, Z1 and Z2, the modules M, M1 and M2, the drive torque T1 and T2, and the amount of movement (movement speed) of the input gear 85, the first gear 81 and the second gear 82 are set to the following values, for example. Then, the above-mentioned smoothness of meshing and suitability of torque and movement speed are examined.

Input gear: M=0.5, Z=49.

First gear: M1=0.8, Z1=14

T1=0.86N, movement of 2.86 mm/motor revolution

Second gear: M2=0.7, Z2=14

T2=0.98N, movement of 2.50 mm/motor revolution

This examination revealed that smoothness of meshing and suitability of torque and movement speed can both be satisfied. That is, with the gear component 80 having the above numerical values, when the second rack 21 of the slider 20 meshes with the second gear 82, a sufficiently high torque is obtained so that the slider 20 can move back and forth without impediment. Furthermore, when the first rack 11 of the disk tray 10 begins to mesh with the first gear 81, and when the second rack 21 of the slider 20 begins to mesh with the second gear 82, since the first gear 81 and the second gear 82 have the same number of teeth Z1 and Z2, the meshing operation is carried out smoothly. In other words, there is no interference between rack teeth of the first and second racks 11 and 21 and gear teeth of the first and second gears 81 and 82 that would result in a loss of operating smoothness. Furthermore, when the first rack 11 of the disk tray 10 meshes with the first gear 81, there is a larger amount of movement so that the disk tray 10 quickly moves forward and backward.

With the gear mechanism of the disk tray device, the drive force (torque), movement speed (amount of movement), etc., of the disk tray 10 and the slider 20 that operate in conjunction with each other can be mechanically controlled to different optimum values. Thus, smoothness of the operations can be ensured. Therefore, the disk tray 10 and the slider 20 can be smoothly driven at separate torque levels and movement speeds with a constant voltage for driving the motor. Furthermore, with the gear mechanism of the disk tray device, since the drive torque and the movement speed of the disk tray 10 and slider 20 can be independently set with a small number of parts, the assembly process can be simplified by reducing the number of parts required.

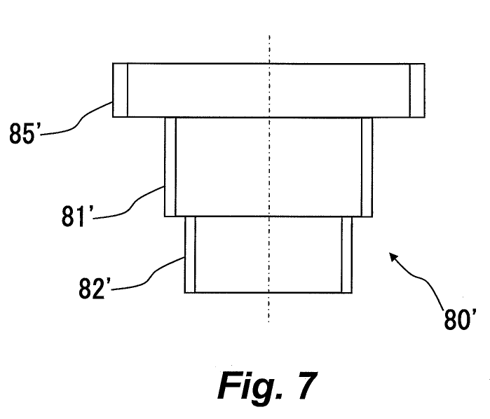

With the gear component 80, the input gear 85 is disposed between the first and second gears 81 and 82. Here, the gear component 80 can have a different structure. For example, as shown in FIG. 7, a gear component 80′ includes an input gear 85′ and first and second gears 81′ and 82′. In view of the similarity between the gear component 80 and the gear component 80′, the parts of the gear component 80′ that are identical to the parts of the gear component 80 will be given the same reference numerals as the parts of the gear component 80. Moreover, the descriptions of the parts of the gear component 80′ that are identical to the parts of the gear component 80 may be omitted for the sake of brevity. The input gear 85′ has an outside diameter that is greater than an outside diameter of the first gear 81′. The first gear 81′ has the outside diameter that is greater than an outside diameter of the second gear 82′. The first gear 81′ is concentrically disposed between the second gear 82′ and the input gear 85′.

### General Interpretation of Terms

In understanding the scope of the present invention, the term “comprising” and its derivatives, as used herein, are intended to be open ended terms that specify the presence of the stated features, elements, components and groups, but do not exclude the presence of other unstated features, elements, components and groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a disk device equipped with the present invention. Accordingly, these terms, as utilized to describe the present invention should be interpreted relative to a disk device equipped with the present invention as used in the normal operating position.

While a preferred embodiment has been chosen to illustrate the present invention, it will be apparent to those skilled in the art from this disclosure that various changes and modifications can be made herein without departing from the scope of the invention as defined in the appended claims. Furthermore, the foregoing description of the preferred embodiment according to the present invention is provided for illustration only, and not for the purpose of limiting the invention as defined by the appended claims and their equivalents.

What is claimed is:

1. A gear mechanism comprising:
a first rack provided to a disk tray that is configured to move between a retracted position and an ejected position;
a second rack provided to a slider that is configured to reciprocally move between a first end position and a second end position; and
a gear component including
a first gear selectively meshed with the first rack to move the disk tray between the retracted position and the ejected position,
a second gear selectively meshed with the second rack to move the slider between the first end position and the second end position, and
an input gear operatively coupled to the first and second gears to transmit a rotation of a motor to the first and second gears,
the first gear and the second gear having equal number of teeth and different modules.

2. The gear mechanism according to claim 1, wherein
the input gear has a different number of teeth from the number of teeth of each of the first and second gears, and has a different module from the modules of the first and the second gears.

3. The gear mechanism according to claim 1, wherein
the gear component is integrally formed as a one-piece, unitary member.

4. The gear mechanism according to claim 3, wherein
the gear component is formed as a three-stage gear by resin molding.

5. The gear mechanism according to claim 3, wherein
the input gear is concentrically disposed between the first gear and the second gear.

6. The gear mechanism according to claim 3, wherein
the input gear has an outside diameter that is greater than outside diameters of the first and second gears.

7. The gear mechanism according to claim 2, wherein
the gear component is integrally formed as a one-piece, unitary member.

8. The gear mechanism according to claim 7, wherein
the gear component is formed as a three-stage gear by resin molding.

9. The gear mechanism according to claim 7, wherein
the input gear is concentrically disposed between the first gear and the second gear.

10. The gear mechanism according to claim 7, wherein
the input gear has an outside diameter that is greater than outside diameters of the first and second gears.

11. The gear mechanism according to claim 1, wherein
the first gear separates from the first rack when the disk tray is located at one of the retracted position and the ejected position, and meshes with the first rack after an initial movement of the disk tray from the one of the retracted position and the ejected position.

12. The disk tray device according to claim 11, wherein
the second gear separates from the second rack when the slider is located at one of the first end position and the second end position, and meshes with the second rack after an initial movement of the slider from the one of the first end position and the second end position.

13. The disk tray device according to claim 12, wherein
a movement of the slider towards the second end position after the initial movement of the slider from the first end position causes the initial movement of the disk tray from the retracted position, and a final movement of the disk tray towards the retracted position causes the initial movement of the slider from the second end position.

14. A disk tray device comprising:
a disk tray movable between a retracted position and an ejected position;
a slider reciprocally slidable between a first end position and a second end position;
a first rack provided to the disk tray;
a second rack provided to the slider; and
a gear component including
a first gear selectively meshed with the first rack to move the disk tray between the retracted position and the ejected position,
a second gear selectively meshed with the second rack to move the slider between the first end position and the second end position, and
an input gear operatively coupled to the first and second gears to transmit a rotation of a motor to the first and second gears,
the first gear and the second gear having equal number of teeth and different modules.
